(19) United States
(12) Patent Application Publication
(10) Pub. No.: US 2026/0175896 A1
(43) Pub. Date: Jun. 25, 2026

(54) VEHICLE BRAKE OPERATING APPARATUS

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi (JP)

(21) Appl. No.: 19/408,804

(22) Filed: Dec. 4, 2025

(30) Foreign Application Priority Data
Dec. 20, 2024 (JP) 2024-224875
Sep. 24, 2025 (JP) 2025-157992

(51) Int. Cl. B62D 1/04; B60T 7/10

(52) U.S. Cl. CPC B62D 1/046; B60T 7/107

(57) ABSTRACT

A vehicle brake operating apparatus includes a steering member configured to be gripped by a hand of a driver for a steering operation, an operation member configured to be provided on the steering member so as to be operable by the hand of the driver, a detection device configured to detect an operation input to the operation member by the hand of the driver, and a controller configured to obtain a detection result of the operation. The operation member is used for at least a brake operation. The controller is configured to control, based on the detection result, a variable mechanism that changes an operation force, an operation amount or both of the operation force and the operation amount, each of which is input to the operation member by the driver along with the brake operation.

### REFERENCE TO RELATED APPLICATIONS

This application claims priority from Japanese Patent Application Nos. 2024-224875 and 2025-157992, filed on December 20, 2024 and September 24, 2025, respectively. The entire contents of the priority applications are incorporated herein by reference.

### TECHNICAL FIELD

The present disclosure relates to a vehicle brake operating apparatus.

### BACKGROUND ART

Conventionally, for example, a joystick device for driving a vehicle disclosed in Japanese Patent No. 6414628 (hereinafter, simply referred to as a “conventional device”) has been known. The conventional device includes an operation lever for a seated driver to perform a brake operation and an accelerator operation with the left hand, and a differential operation lever for operating a steering wheel with the right hand. In the conventional device, the driver can drive the vehicle by operating the left and right operation levers without operating a brake pedal and an accelerator pedal disposed at the feet of the driver.

### SUMMARY

In the conventional device, an operation lever for performing a brake operation and an accelerator operation is mechanically connected to the brake pedal and the accelerator pedal. For this reason, in the conventional device, although the driver operates the operation lever by hand, it is necessary to operate the operation lever in accordance with the operation characteristics, that is, the operation force and the stroke amount, when operating the brake pedal and the accelerator pedal by foot. That is, the conventional device does not have an operation characteristic suitable for the driver to operate the operation lever by hand, and as a result, the driver may feel uncomfortable.

An object of the present disclosure is to provide a vehicle brake operating apparatus capable of changing an operation characteristic when operated by a driver with the hand.

An aspect of the present disclosure relates to a vehicle brake operating apparatus includes a steering member configured to be gripped by a hand of a driver for a steering operation, an operation member configured to be provided on the steering member so as to be operable by the hand of the driver, a detection device configured to detect an operation input to the operation member by the hand of the driver, and a controller configured to obtain a detection result of the operation. The operation member is used for at least a brake operation. The controller is configured to control, based on the detection result, a variable mechanism that changes an operation force, an operation amount or both of the operation force and the operation amount, each of which is input to the operation member by the driver along with the brake operation.

According to the present disclosure, the operation, that is, the operation force and the operation amount, of the operation member provided on the steering member can be controlled to be changed based on the detection result by the detection device. As a result, the driver can perform the brake operation on the operation member by the operation force and the operation amount (the operation characteristic) that the driver can input to the operation member. Therefore, it is possible to suppress a sense of discomfort felt when the driver decelerates the vehicle by manually performing the brake operation on the operation member.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which;

FIG. 1 is a schematic configuration diagram for explaining a vehicle to which a brake operating apparatus according to an embodiment of the present disclosure is applied;

FIG. 2 is a conceptual front view of a steering member and a brake operating apparatus;

FIG. 3 is a diagram for explaining a configuration of the brake operating apparatus;

FIG. 4 is a perspective view for explaining a variable mechanism;

FIG. 5 is a flowchart of a brake characteristic setup program;

FIG. 6 is a diagram for explaining an F-S diagram;

FIG. 7 is a perspective view for explaining a variable mechanism according to a first modification;

FIG. 8 is a top view for explaining a variable mechanism according to the first modification before the variable mechanism is actuated;

FIG. 9 is a top view for explaining a state after the operation of the variable mechanism according to the first modification;

FIG. 10 is a perspective view for explaining a variable mechanism according to a second modification;

FIG. 11 is a perspective view for explaining a crank member and an eccentric disk;

FIG. 12 is a top view for explaining a bearing;

FIG. 13 is a top view for explaining the variable mechanism according to the second modification before the variable mechanism is actuated; and

FIG. 14 is a top view for explaining the variable mechanism according to the second modification after the operation.

### DESCRIPTION

Hereinafter, a vehicle brake operating apparatus 10 according to an embodiment of the present disclosure will be described in detail with reference to the drawings. It is noted that, in addition to the embodiments described below, the present disclosure can be implemented in various forms with various modifications and improvements based on the knowledge of those skilled in the art.

### CONFIGURATION OF VEHICLE TO WHICH VEHICLE BRAKE OPERATING APPARATUS IS APPLIED

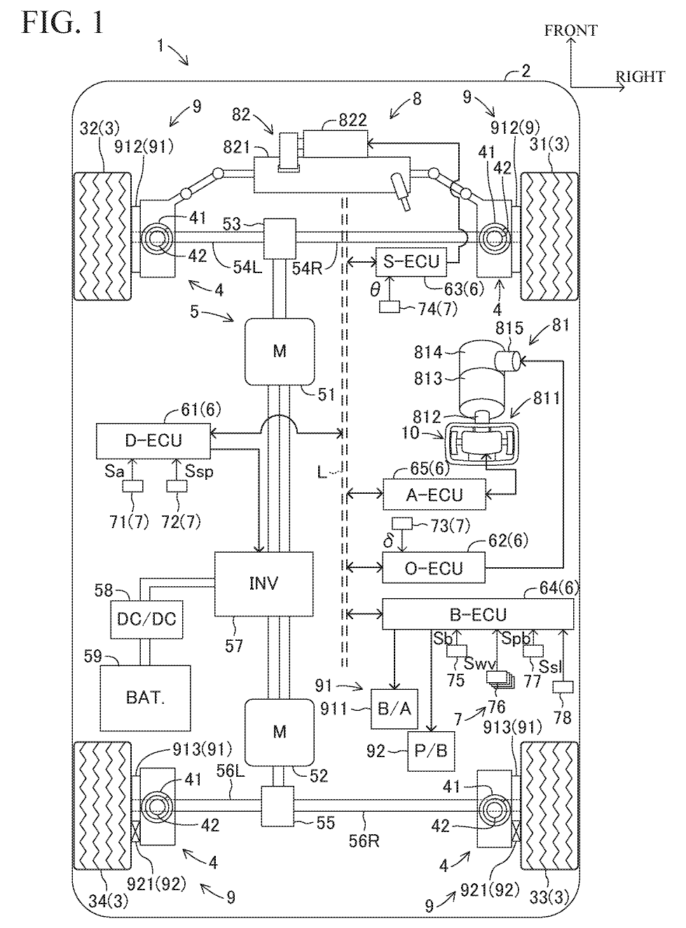

In the present embodiment, the vehicle brake operating apparatus 10 is applied to the vehicle 1 shown in FIG. 1. The vehicle 1 includes a vehicle body 2, wheels 3 disposed on the front, rear, left, and right sides, and a suspension unit 4 that supports the vehicle body 2 and the wheels 3. The wheels 3 include a right front wheel 31, a left front wheel 32, a right rear wheel 33, and a left rear wheel 34. The suspension unit 4 includes, for example, a coil spring 41 and a shock absorber 42.

The vehicle 1 includes a drive system 5 that generates and transmits a driving force necessary for traveling. In the present embodiment, the drive system 5 includes a front motor 51 and a rear motor 52. The front motor 51 drives the right front wheel 31 and the left front wheel 32 by transmitting rotation of an output shaft to left and right front wheel axles 54L and 54R via a differential gear 53 (including a reduction gear). The rear motor 52 drives the right rear wheel 33 and the left rear wheel 34 by transmitting rotation of an output shaft to left and right rear wheel axles 56L and 56R via a differential gear 55 (including a reduction gear). That is, in the present embodiment, a four-wheel-drive electric vehicle (EV) is exemplified as the vehicle 1.

The drive system 5 includes an inverter 57, a DC/DC converter 58, and a battery 59. As a result, the front motor 51 and the rear motor 52 can be independently driven in a forward rotation in a forward direction of the vehicle 1 and a reverse rotation in a backward direction of the vehicle 1 by an energization control of the inverter 57.

The inverter 57 has a charging port (not shown), and has, for example, a charging function of converting an alternating current supplied from a charging facility into a direct current and charging the battery 59 via the DC/DC converter 58. Moreover, the inverter 57 also has a function of, for example, converting an alternating current generated by the rear motor 52 by regenerative braking into a direct current and charging the battery 59 via the DC/DC converter 58, that is, a function of storing regenerative energy.

The front motor 51 and the rear motor 52 are controlled by a drive electronic control unit 61 (hereinafter, simply referred to as a “drive ECU 61”) included in a controller 6. The drive ECU 61 is an electronic control unit including, as a main part, a microcomputer having a CPU, a ROM, a RAM, and various interfaces. It is noted that, in FIG. 1, the drive ECU 61 is referred to as “D-ECU 61”.

The drive ECU 61 obtains a detection signal Sa corresponding to a stroke amount S detected by a stroke sensor 121 as a detection device, which will be described in detail later. The detection signal Sa is a detection signal detected by an accelerator pedal sensor 71 that detects an operation amount (hereinafter, also referred to as an “accelerator operation amount”) when an operation lever 11 constituting the vehicle brake operating apparatus 10, in a sensor group 7, which will be described later, is operated so as to accelerate the vehicle 1. Thus, the drive ECU 61 calculates driver-requested driving force corresponding to the accelerator operation amount based on the detection signal Sa. As will be described later, in the present embodiment, a case where the vehicle 1 is accelerated by a seated driver pulling and operating the operation lever 11 rearward in a front-rear direction of the vehicle 1 will be exemplified.

Moreover, the drive ECU 61 obtains an operation position (or an operation state) of a shift operation member such as a shift lever, a shift switch, or a shift selector (not illustrated) that is operated when the vehicle 1 is moved forward or backward or parked. Therefore, the drive ECU 61 receives a detection signal Ssp indicating an operation position (operation state) output from a shift position sensor 72, in the sensor group 7, that detects the operation position (operation state) of the shift operation member.

Moreover, the vehicle 1 includes a steering system 8 that steers the right front wheel 31 and the left front wheel 32 as steered wheels during traveling. The steering system 8 is of a steer-by-wire type including an operating device 81 and a steering device 82 that are mechanically independent of each other.

The operation device 81 includes a steering wheel 811 as a steering member, a steering shaft 812, and a steering column 813. Moreover, the operation device 81 includes a reaction force applying actuator 814 and a reaction force motor 815 as a driving force source of the reaction force applying actuator 814.

The steering wheel 811 is gripped by the driver and is rotated when the steered wheels are steered. The steering wheel 811 of the present embodiment is formed in a rectangular shape as a whole. It is noted that, in the present embodiment, a case where the rectangular steering wheel 811 is employed will be described as an example. However, the shape of the steering wheel 811 is not limited to the rectangular shape, and a polygonal shape other than the rectangular shape, a circular shape, or an H shape can also be adopted.

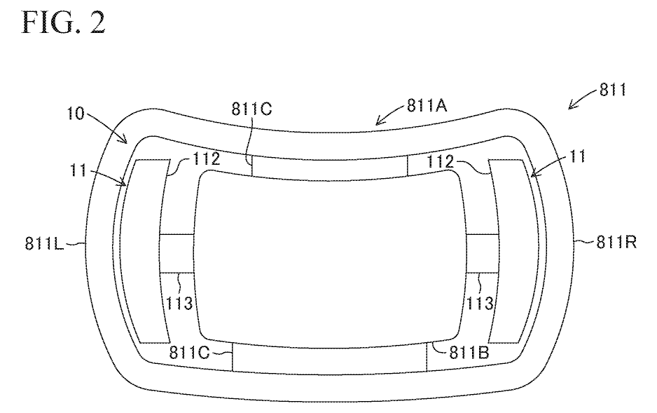

As illustrated in FIG. 2, the steering wheel 811 includes a frame-shaped portion 811A formed in a frame shape, a central portion 811B disposed inside the frame of the frame-shaped portion 811A, and a coupling portion 811C coupling the frame-shaped portion 811A and the central portion 811B. The frame-shaped portion 811A is provided with grip portions 811L and 811R to be gripped by the driver at left and right portions when viewed from the seated driver. As a result, the driver grips the right grip portion 811R with the right hand and grips the left grip portion 811L with the left hand to rotate the steering wheel 811 and push and pull the operation lever 11 as described later in detail.

As shown in FIG. 1, the central portion 811B is assembled to a distal end side of the steering shaft 812 that is supported by the steering column 813 so as to be rotatable about its axis. The reaction force applying actuator 814 is coaxially connected to the steering column 813, and a driving force, that is, a reaction force of the reaction force motor 815, is transmitted to the steering wheel 811 that is rotationally operated via the steering shaft 812.

The reaction force motor 815 of the operation device 81 is controlled by an operation electronic control unit 62 (hereinafter, simply referred to as an “operation ECU 62 ”) included in the controller 6. The operation ECU 62 is an electronic control unit including, as a main part, a microcomputer having a CPU, a ROM, a RAM, and various interfaces. The operation ECU 62 is connected to a communication line L via various interfaces. It is noted that, in FIG. 1, the operation ECU 62 is referred to as an “O-ECU 62”. The operation ECU 62 is connected to an operation angle sensor 73, of the sensor group 7, that detects an operation angle δ indicating a rotational operation position of the steering wheel 811.

The steering device 82 steers the right front wheel 31 and the left front wheel 32, which are steerably supported by the vehicle body 2, as a single unit. The steering device 82 includes a steering actuator 821. The steering actuator 821 includes a tie rod, a steering rod, a housing, and a rod moving mechanism. Moreover, the steering actuator 821 includes a steering motor 822 as a driving force source for moving the rod moving mechanism.

A control of the steering motor 822 of the steering device 82 is performed by a steering electronic control unit 63 (hereinafter, simply referred to as a “steering ECU 63” in some cases) included in the controller 6. The steering ECU 63 is an electronic control unit including, as a main part, a microcomputer having a CPU, a ROM, a RAM, and various interfaces. The steering ECU 63 is connected to the communication line L via various interfaces. It is noted that, in FIG. 1, the steering ECU 63 is referred to as “S-ECU 63”. The steering ECU 63 is connected to a steering angle sensor 74, of the sensor group 7, that detects a steering angle θ indicating a steering position of the right front wheel 31 and the left front wheel 32.

Moreover, the vehicle 1 also includes a brake system 9 that generates a braking force necessary for braking. The brake system 9 includes a hydraulic brake device 91 that applies, separately from the regenerative braking by the rear motor 52 described above, a braking force to each of the wheels 3 and an electric parking brake device 92 that applies a braking force to each of the right rear wheel 33 and the left rear wheel 34 when the vehicle 1 is stopped in the present embodiment.

The hydraulic brake device 91 applies a braking force (hereinafter, the braking force by the hydraulic brake device 91 may also be referred to as “friction braking force ”) to each wheel 3 in accordance with an operation of the operation lever 11 of the vehicle brake operating apparatus 10 , which will be described later. Therefore, the hydraulic brake device 91 includes a brake actuator 911 that regulates, in accordance with the operation of the operation lever 11, the pressure of the hydraulic oil pressurized by a pump and supplies the regulated hydraulic oil. That is, in the brake system 9 of the present embodiment, the hydraulic brake device 91 is a brake-by-wire type in which the mechanical connection between the operation lever 11 operated by the driver and the brake actuator 911 that applies the friction braking force to the wheel 3 is released. It is noted that, in FIG. 1, the brake actuator 911 is indicated as “B/A911”. Further, the hydraulic brake device 91 includes a front-wheel-side brake 912 that decelerates the rotations of each of the right front wheel 31 and the left front wheel 32, and a rear-wheel-side brake 913 that decelerates the rotations of each of the right rear wheel 33 and the left rear wheel 34

The brake actuator 911 is an actuator that supplies the front-wheel-side brake 912 and the rear-wheel-side brake 913 with the hydraulic oil whose pressure is adjusted in accordance with a brake operation amount Ob (that is, corresponding to a stroke amount S and an operation force F each described later) of the operation lever 11 operated by the driver. Here, for example, the brake actuator 911 can apply the friction braking force to the wheels 3 by independently controlling the hydraulic pressure supplied to each of the front-wheel-side brake 912 and the rear-wheel-side brake 913, for the right front wheel 31 and the left front wheel 32, that is, the front wheel side, and the right rear wheel 33 and the left rear wheel 34, that is, the rear wheel side. It is noted that, the brake actuator 911 can also apply different friction braking forces to the respective wheels 3 by independently controlling the hydraulic pressures of the four wheels.

Therefore, the brake actuator 911 is configured to include a pump or an electric cylinder each driven by an electric motor, a control holding valves that regulates the pressure of the hydraulic oil pressurized by the pump or the electric cylinder and supplies the hydraulic oil to the front-wheel-side brake 912 and the rear-wheel-side brake 913, a shut-off valve that is a normally closed electromagnetic on-off valve, and the like, which are not illustrated because a well-known configuration can be adopted. Thus, the brake actuator 911 can supply the pressure-regulated hydraulic oil to the front-wheel-side brake 912 and the rear-wheel-side brake 913 in accordance with the brake operation by the driver via the operation lever 11.

As each of the front-wheel-side brake 912 and the rear-wheel-side brake 913, a well-known disc brake or drum brake can be adopted. That is, although not illustrated, the front-wheel-side brake 912 and the rear-wheel-side brake 913 include a brake disc that rotates integrally with the wheel 3, a pair of brake pads, and a brake caliper (wheel cylinder) when a disc brake is employed, and include a brake drum that rotates integrally with the wheel 3, a pair of brake shoes, and a wheel cylinder when a drum brake is employed.

As a result, in the hydraulic brake device 91, when the pressurized and regulated hydraulic oil is supplied from the brake actuator 911 to the front-wheel-side brake 912 and the rear-wheel-side brake 913, the brake pad presses the brake disc to generate a friction braking force. Alternatively, in the hydraulic brake device 91, when the pressurized and regulated hydraulic oil is supplied from the brake actuator 911 to the front-wheel-side brake 912 and the rear-wheel-side brake 913, the brake shoe presses the brake drum to generate a friction braking force.

Since a conventional structure may be employed, a detailed explanation is not provided here, however, as shown in FIG. 1, the electric parking brake device 92 includes an electric actuator 921 for mechanically braking the right rear wheel 33 and the left rear wheel 34. For example, when the hydraulic brake device 91 employs a disc brake, the electric actuator 921 is provided in a brake caliper. In the electric parking brake device 92, when a switch operation or the like is performed by the driver, the electric actuator 921 presses a brake pad accommodated in the brake caliper against a brake disc by a driving force of an electric motor, thereby generating a braking force.

The control of the brake actuator 911 and the control of the electric actuator 921 are performed by a brake electronic control unit 64 (hereinafter, simply referred to as a “brake ECU 64” in some cases) included in the controller 6. The brake ECU 64 is an electronic control unit including, as a main part, a microcomputer having a CPU, a ROM, a RAM, and various interfaces. The brake ECU 64 is connected to the communication line L via various interfaces. It is noted that, in FIG. 1, the brake ECU 64 is denoted by “B-ECU 64”.

The brake ECU 64 is connected to each of a brake sensor 75 (including the stroke sensor 121 that detects the stroke amount S to be described later) that detects an operation amount of the operation lever 11, four wheel speed sensors 76 that detect wheel speeds of the respective wheels 3, a parking brake sensor 77, and a gyro sensor 78 of the sensor group 7. The brake ECU 64 receives a detection signal Sb indicating an operation (the stroke amount S as an operation amount and the operation force F having a predetermined relationship with the stroke amount S) detected by the brake sensor 75 (stroke sensor 121), and calculates a required braking force corresponding to the brake operation. Then, the brake ECU 64 calculates the friction braking force to be generated by each of the front-wheel-side brake 912 and the rear-wheel-side brake 913 and the regenerative braking force to be generated by the rear motor 52 so as to realize the required braking force.

Here, the brake ECU 64 controls the operation of the brake actuator 911 based on a detection signal Swv of each of the wheel speed sensors 76 so as to generate the calculated friction braking force. As a result, the brake actuator 911 pressurizes the hydraulic oil and supplies the pressurized hydraulic oil to each of the front-wheel-side brake 912 and the rear-wheel-side brake 913, and each of the front-wheel-side brake 912 and the rear-wheel-side brake 913 applies the friction braking force to each wheel 3. Moreover, the brake ECU 64 transmits information indicating the calculated regenerative braking force to the drive ECU 61.

Moreover, when the electric parking brake device 92 applies the braking force to the right rear wheel 33 and the left rear wheel 34, the brake ECU 64 receives a detection signal Spb output from the parking brake sensor 77 and indicating a state where the electric parking brake device 92 applies the braking force. Further, the brake ECU 64 receives, from the gyro sensor 78, a detection signal Ssl representing an inclination of the vehicle 1, that is, a slope gradient which is an inclination of a road surface on which the vehicle 1 is stopped, in a longitudinal direction.

### CONFIGURATION OF VEHICLE BRAKE OPERATING SYSTEM

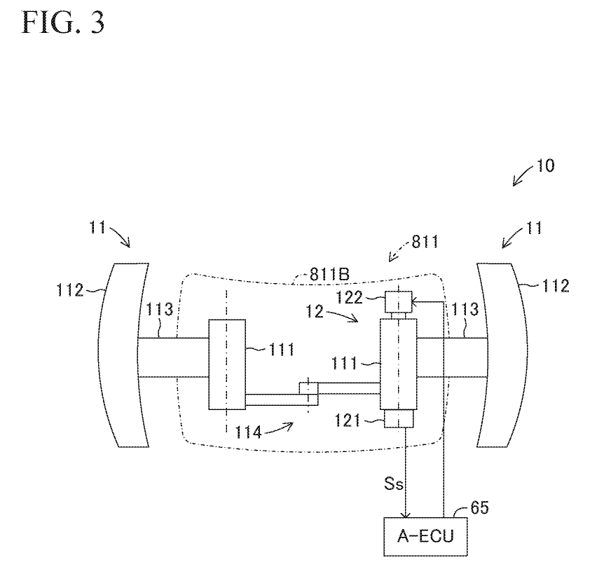

Further, as shown in FIGS. 2 and 3, the vehicle 1 includes the vehicle brake operating apparatus 10 that is operated by the driver when decelerating the vehicle 1. The vehicle brake operating apparatus 10 is operated by a driver's hand. For this reason, the vehicle brake operating apparatus 10 includes the pair of left and right operating levers 11 disposed so as to be adjacent to the grip portions 811L and 811R gripped by the driver at the inside the frame-shaped portion 811A of the steering wheel 811 when viewed from the seated driver.

As shown in FIG. 3, the operation lever 11 includes a base 111, an operation portion 112, and a coupling member 113. The base 111 is formed in a tubular shape or a columnar shape having a circular cross section or a rectangular cross section, is accommodated in the central portion 811B, and is provided so as to be rotatable around a rotation axis extending in a vertical direction in a state where the steering wheel 811 is in a neutral position. The operation portion 112 is formed in a plate shape, and is subjected to a pushing operation (corresponding to a “brake operation” in the present embodiment) by a hand of the driver (more specifically, a thumb of the driver) and a pulling operation (corresponding to, for example, an “accelerator operation” for accelerating the vehicle 1) by the hand of the driver (more specifically, an index finger, a middle finger, or the like of the driver). The coupling member 113 is formed in a rod shape and couples the base 111 and the operation portion 112.

Here, the left and right bases 111 are connected to each other by a link mechanism 114 so as to rotate in opposite directions in conjunction with each other. As a result, for example, when only the operation portion 112 of the operation lever 11 on the right side in FIG. 3 is pushed and the base 111 rotates, the base 111 on the left side connected by the link mechanism 114 rotates in a rotation direction opposite to the rotation direction of the base 111 on the right side. Therefore, the operation portion 112 coupled to the left base 111 via the coupling member 113 moves in a pushing operation direction in accordance with the rotation of the left base 111 even when the pushing operation for the left-side operation portion 112 is not performed by the driver. Similarly, when the right-side operation lever 11 is pulled in, the left-side operation lever 11 moves in a pulling operation direction in conjunction with the right operation lever 11. That is, in the vehicle brake operating apparatus 10, when one of the left and right operating levers 11 is pushed or pulled, the other operating lever 11 moves in the pushing operation direction or the pulling operation direction in conjunction therewith.

It is noted that, in the vehicle brake operating apparatus 10, when the operation lever 11 is pulled in, the operation lever 11 can function as a normal accelerator so as to change the acceleration of the vehicle 1 and accelerate the vehicle 1. That is, in the present embodiment, the hydraulic brake device 91 of the brake system 9 is operated to decelerate the vehicle 1 when the driver pushes the operation portion 112, and the front motor 51 and the rear motor 52 of the drive system 5 are driven to accelerate the vehicle 1 when the driver pulls the operation portion 112.

Here, in a state where the operation portion 112 is not operated, the operation portion 112 is maintained at a neutral position by a biasing force of a biasing member (for example, a spring, a torsion bar, or the like, not illustrated) that biases the operation portion 112 toward a boundary operation position, that is, a neutral position, between the pushing operation and the pulling operation. Therefore, the driver inputs the operation force F against the biasing force of the biasing member to the operation portion 112 to perform the pushing operation or the pulling operation on the operation portion 112.

In addition, the vehicle brake operating apparatus 10 includes a variable mechanism 12 that realizes a change in the operating force F and the stroke amount S with which the driver pushes the operation portion 112 particularly when decelerating the vehicle 1. The variable mechanism 12 is a mechanism that assists the driver to easily push the operation portion 112 when the driver pushes the operation portion 112, that is, to increase or decrease at least one of the operation force F and the stroke amount S when pushing the operation portion 112.

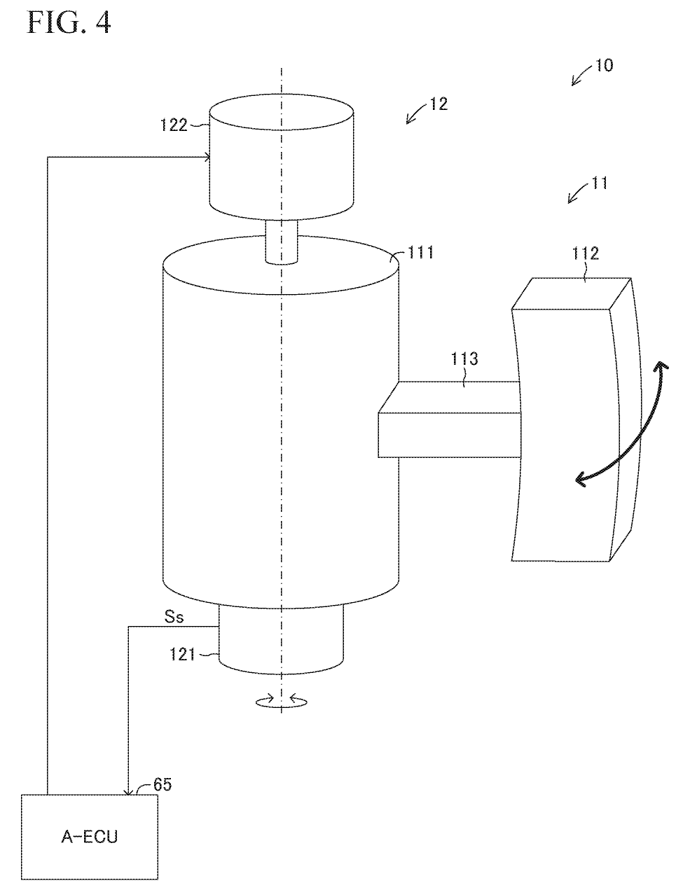

Therefore, as shown in FIG. 4, the variable mechanism 12 of the present embodiment includes the stroke sensor 121 as a detection device and an electric motor 122 as a change device. The stroke sensor 121 is coaxially disposed and connected to the base 111. The stroke sensor 121 detects the stroke amount S of the operation lever 11, in other words, a rotation amount (rotation angle) around the rotation axis of the base 111 corresponding to the operation of the driver. The stroke sensor 121 outputs a detection signal Ss indicating the stroke amount S (rotation amount) to an adjustment electronic control unit 65 described later.

It is noted that, in the present embodiment, a case where the stroke sensor 121 is disposed coaxially below with respect to the base 111 in the vertical direction in a state where the steering wheel 811 is in the neutral position is illustrated. However, the arrangement of the stroke sensor 121 is not limited thereto. For example, the stroke sensor 121 may be arranged coaxially above with respect to the base 111 in the vertical direction, or the stroke sensor 121 may be arranged parallel with respect to the base 111.

The electric motor 122 is, for example, a brushless motor or a stepping motor, and is coaxially disposed and coupled to the base 111. The electric motor 122 generates an assist force so as to realize a brake operation characteristic described later. Here, in the state where the steering wheel 811 is in the neutral position, the electric motor 122 is disposed coaxially above with respect to the base 111 in the vertical direction. That is, the electric motor 122 is disposed on the opposite side of the stroke sensor 121 with respect to the base 111. It is noted that, as described above, when the stroke sensor 121 is disposed coaxially above with respect to the base 111 in the vertical direction, the electric motor 122 is disposed coaxially below with respect to the base 111 in the vertical direction.

Specifically, as shown in FIG. 4, the driver who drives the vehicle 1 needs to push the operation lever 11 particularly when decelerating the vehicle 1. In this case, it may be a burden for a powerless driver to input the operation force F for pushing the operation lever 11 against the above-described biasing force or to secure the stroke amount S necessary for operating the hydraulic brake device 91 to generate the friction braking force. On the other hand, for a powerful driver, the reaction force caused by the biasing force is small when the operation lever 11 is pushed, that is, the response is small, and for example, the driver may feel uncomfortable in the operability when the driver operates the operation lever 11 delicately.

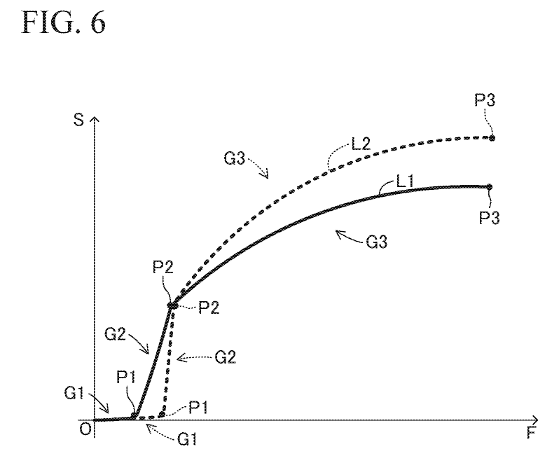

Therefore, the electric motor 122 generates the assist force so as to realize the brake operation characteristic preferred by the driver, that is, the F-S diagram (see FIG. 6) indicating the relationship between the operation force F and the stroke amount S. As a result, the powerless driver can easily secure the operation force F and the stroke amount S required for the pushing operation of the operation lever 11. On the other hand, the powerful driver can feel a good response when delicately operating the operation lever 11.

It is noted that the stroke sensor 121 and the electric motor 122 constituting the variable mechanism 12 can be provided in each of the pair of left and right operation levers 11. However, in the vehicle brake operating apparatus 10, as described above, the left and right operating levers 11 are configured to move by the same stroke amount S in the same direction in conjunction with each other by the link mechanism 114. As a result, the stroke sensor 121 and the electric motor 122 may be provided on only one of the pair of right and left bases 111, for example, only the base 111 on the right side in FIG. 3. In this case, it is possible to avoid redundantly providing the stroke sensor 121 and the electric motor 122, and it is possible to configure the vehicle brake operating apparatus 10 at low cost. Therefore, in the following description, as shown in FIG. 3, a case where the stroke sensor 121 and the electric motor 122 are provided only on the right base 111 will be described as an example.

The electric motor 122 of the variable mechanism 12 is controlled by the adjustment electronic control unit 65 (hereinafter, may be simply referred to as an “adjustment ECU 65”) included in the controller 6. The adjustment ECU 65 is an electronic control unit including, as a main part, a microcomputer having a CPU, a ROM, a RAM, and various interfaces. As shown in FIG. 4, the stroke sensor 121 is connected to the adjustment ECU 65. The adjustment ECU 65 is connected to the communication line L via various interfaces (see FIG. 1).

As a result, the adjustment ECU 65 can communicate with the drive ECU 61 and the brake ECU 64 via the communication line L, and can output a request to the drive ECU 61 and the brake ECU 64, that is, the detection signal Ss corresponding to an operation of the driver detected by the stroke sensor 121, and can input various detection signals from the sensor group 7 via the drive ECU 61 and the brake ECU 64. The adjustment ECU 65 executes a brake characteristic setup program described below and controls the operation of the electric motor 122 in accordance with the set up brake characteristic, thereby realizing the brake operation characteristic preferred by the driver. It is noted that, in FIG. 1 and the like, the adjustment ECU 65 is referred to as an “A-ECU 65”.

### DESCRIPTION OF OPERATION OF VEHICLE BRAKE OPERATING SYSTEM

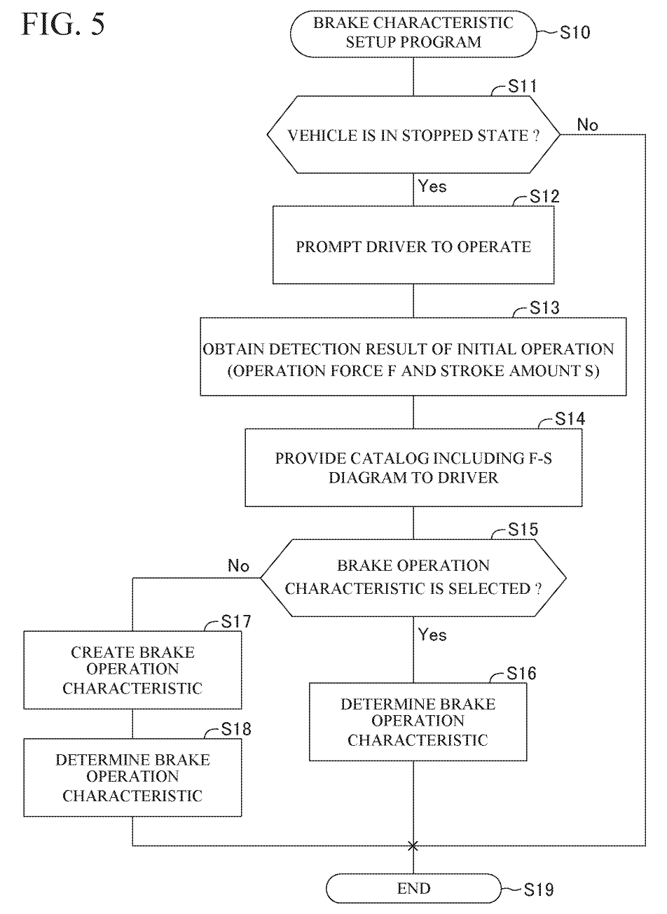

Next, the operation of the vehicle brake operating apparatus 10 according to the present embodiment will be described with reference to FIGS. 4, 5, and 6. When the ignition of the vehicle 1 transitions from the OFF state to the ON state, in other words, when the power supply of the vehicle 1 transitions from the OFF state to the ON state, the adjustment ECU 65 starts execution of the brake characteristic setup program illustrated in FIG. 5 in step S10. It is noted that the brake characteristic setup program may be executed every time the ignition is changed from the OFF state to the ON state, or may be executed when there is an instruction from the driver (for example, an instruction of a change of the driver).

In subsequent step S11, the adjustment ECU 65 determines whether or not the vehicle 1 is in a stopped state. Specifically, the adjustment ECU 65 obtains the detection signal Ssp detected by the shift position sensor 72 from the drive ECU 61 via the communication line L. When determining based on the detection signal Ssp that the operation position of the shift operation member is the parking position (P range), the adjustment ECU 65 determines that the vehicle 1 is in the stopped state because a predetermined condition is satisfied. In addition to or instead of this, the adjustment ECU 65 obtains the detection signal Swv detected by the wheel speed sensor 76 from the brake ECU 64 via the communication line L. When the wheel speed of the wheel 3 is “0”, that is, the vehicle speed of the vehicle 1 is “0”, the adjustment ECU 65 determines that the vehicle 1 is in the stopped state based on the detection signal Swv.

Further, in addition to or instead of these, the adjustment ECU 65 obtains the detection signal Spb detected by the parking brake sensor 77 from the brake ECU 64 via the communication line L. Then, based on the detection signal Spb, the adjustment ECU 65 determines that the vehicle 1 is in the stopped state when the electric parking brake device 92 is in the ON state, that is, when the electric parking brake device 92 is operating to apply the braking force to the wheels 3 (the right rear wheel 33 and the left rear wheel 34).

It is noted that the determination of the stopped state of the vehicle 1 can be made based on at least one of the detection signal Ssp from the shift position sensor 72, the detection signal Swv from the wheel speed sensor 76, or the detection signal Spb from the parking brake sensor 77, and can also be made based on, for example, the detection signal Ssl from the gyro sensor 78. That is, the adjustment ECU 65 obtains the detection signal Ssl detected by the gyro sensor 78 from the brake ECU 64 via the communication line L. Then, based on the detected detection signal Ssl, the adjustment ECU 65 determines that the vehicle 1 is in the stopped state when the gradient of the parking lot or the road where the vehicle 1 is present is a gradient at which the vehicle 1 can maintain the stopped state.

When the vehicle is in the stopped state, the adjustment ECU 65 makes a “Yes” determination, and executes step processing of step S12. On the other hand, the adjustment ECU 65 determines “No” when the vehicle is not in the stopped state, and temporarily ends the execution of the program in step S19. Then, the adjustment ECU 65 starts execution of the program again in step S10 after a predetermined short time has elapsed.

In step S12, the adjustment ECU 65 prompts the driver to operate the operation lever 11, that is, to perform an initial operation. That is, in the present embodiment, the adjustment ECU 65 prompts the brake operation of pushing the operation lever 11 as the initial operation. Specifically, the adjustment ECU 65 prompts the driver to push the operation lever 11, that is, to perform the brake operation so that the stroke becomes equal to or greater than a predetermined stroke. As a result, the adjustment ECU 65 outputs a notification (hereinafter, also referred to as a “brake notification”) for prompting the driver to perform the brake operation.

Here, the brake notification is, for example, displayed by a message prompting the driver to perform the brake operation using characters or images on a display device disposed in the vehicle so that the driver can see the message, provided by lighting a lamp, or guided by voice. Specifically, for example, the adjustment ECU 65 can display the text message such as “Please press the operation lever” on the display device, and display the operation state of the operation lever 11 in a video. It is noted that examples of the display device include a display in a meter cluster and a touch panel type center display disposed on a dash panel for operating navigation, audio, and the like.

Then, when the driver performs the brake operation on the operation lever 11 in accordance with the brake notification, for example, pushes the operation portion 112 in a depth direction of the paper surface in FIG. 4, the adjustment ECU 65 executes step processing of step S13. It is noted that, in the present embodiment, the brake notification is performed after the power supply of the vehicle 1 is turned on. However, for example, when the vehicle 1 is in a stop maintaining state due to waiting for a traffic light or the like, the processing may be executed at a predetermined timing. In this case, the driver can reliably perform the brake operation by the brake notification.

Further, in the present embodiment, a case where the brake notification is executed to the driver in step S12 will be exemplified. However, when the driver drives (starts) the vehicle 1, the driver usually moves the operation position of the shift operation member from the parking position in a state where the brake operation is performed on the operation lever 11. Therefore, when the brake characteristic setup program is executed, for example, if the driver has already performed the brake operation on the operation lever 11 before the execution of the step processing of step S12, the execution of the step processing of step S12 can be omitted.

In step S13, the adjustment ECU 65 obtains, as detection results, the operation force F and the stroke amount S (operation amount) due to the pushing operation of the operation lever 11 by the driver, that is, the initial operation of the operation lever 11 which are detected along with the brake operation. In this manner, the adjustment ECU 65 obtains the detection result of the initial operation, that is, the operation force F and the stroke amount S, and thus it is possible to grasp the ease of operation of the driver with respect to the operation lever 11, that is, whether the driver operates the operation lever 11 with a weak force or a strong force.

Specifically, the adjustment ECU 65 obtains the detection signal Ss indicating the stroke amount S of the operation lever 11 from the stroke sensor 121. Further, in the present embodiment, the adjustment ECU 65 obtains the reaction force against the pushing operation of the operation lever 11, that is, the operation force F input to the operation lever 11 by the driver. The reaction force has a predetermined relationship with the stroke amount S. When the adjustment ECU 65 obtains the stroke amount S and the operation force F, the adjustment ECU 65 executes step processing of step S14.

Here, the adjustment ECU 65 can calculate a stroke speed from the stroke amount S indicated by the detection signal Ss, for example. It is noted that the stroke speed is a change amount of the stroke amount per unit time. Then, the adjustment ECU 65 can obtain the reaction force against the pushing operation of the operation lever 11, that is, the operation force F input to the operation lever 11 by the driver. The reaction force has a predetermined relationship with the calculated stroke speed.

Further, in the present embodiment, a case where the reaction force, that is, the operation force F, is obtained based on the detected stroke amount S or the stroke speed calculated from the stroke amount S based on the predetermined relationship set in advance will be exemplified. However, for example, the adjustment ECU 65 can also input the stroke amount S detected by the stroke sensor 121 in accordance with the operation of the operation lever 11 by the driver and the force (torque), that is the operation force F, input to the electric motor 122 via the base 111 in accordance with the operation of the operation lever 11.

In step S14, as shown in FIG. 6, the adjustment ECU 65 displays the relationship between the operation force F and the stroke amount S stored in advance (hereinafter, this relationship may be referred to as an “F-S diagram”) based on the detection result so as to be selectable by the driver. That is, the adjustment ECU 65 provides a catalog including a plurality of F-S diagrams to the driver via the display device. It is noted that, in FIG. 6, two F-S diagrams are shown for the sake of explanation. Here, each of the plurality of F-S diagrams shown in the catalog, that is, the relationship between the operation force F and the stroke amount S, consists of a rising region gradient G1 representing a rising gradient (inclination) at an initial stage of the operation from an origin O to a point P1, that is, a rising load, a normal region gradient G2 representing a gradient (inclination) when the stroke amount S increases in a normal deceleration range from the point P1 to a point P2, and a high deceleration region gradient G3 in which the operation force F increases as the stroke amount S increases from the point P2 to a point P3 to generate a high deceleration.

As compared with a F-S line L2 indicated by a broken line in FIG. 6, a F-S line L1 indicated by a solid line in FIG. 6 has a characteristic in which the rising operation force F of the F-S line L1 is smaller than that of the F-S line L2 at the point P1 in the rising gradient G1, the gradient of the F-S line L1 is small in the normal region gradient G2, that is, the operation force F gradually increases as the stroke amount S increases, and the gradient of the F-S line L1 is small in the high deceleration region gradient G3, that is, the increase in the stroke amount S is small as the operation force F increases. That is, the F-S line L1 is a brake operation characteristic suitable for a driver who has a strong force when pushing the operation lever 11. In other words, the F-S line L1 is the brake operation characteristic in which the assist by the electric motor 122 is small as a whole, the stroke amount S required for the driver's brake operation is small, and the operation force F is large.

On the other hand, as compared with the F-S line L1, the F-S line L2 has a characteristic in which the rising operation force F of the F-S line L2 is larger than that of the F-S line L1 at the point P1 in the rising gradient G1, but the gradient of the F-S line L2 is large in the normal region gradient G2, that is, the operation force F is substantially constant as the stroke amount S increases, and the gradient of the F-S line L2 is large in the high deceleration region gradient G3, that is, the increase in the stroke amount S is large as the operation force F increases. That is, the F-S line L2 is a brake operation characteristic suitable for a weak driver when pushing the operation lever 11. In other words, the F-S line L2 is the brake operation characteristic in which the assist by the electric motor 122 is large as a whole, the stroke amount S required for the driver's brake operation is large, and the operation force F is small.

It is noted that, in the present embodiment, the case where the plurality of brake operation characteristics are shown in the catalog, and the driver selects an arbitrary brake operation characteristic is exemplified. However, the adjustment ECU 65 can also generate and provide one brake operation characteristic according to the operation state of the operation lever 11 by the driver based on the detection result obtained in step S13, that is, the operation force F and the stroke amount S. Moreover, in the present embodiment, the case where both the operation force F and the stroke amount S are changed in accordance with the F-S diagram is exemplified. However, it is also possible to change only one of the operation force F and the stroke amount S according to the F-S diagram as necessary.

Returning to FIG. 5 again, in step S15, the adjustment ECU 65 determines whether or not the driver has selected one of the plurality of F-S diagrams shown in the catalog, in other words, one of the brake operation characteristics. That is, for example, when any one brake operation characteristic, specifically, the F-S line L1 or the F-S line L2, is selected from the catalog by a touch operation to the display device, the adjustment ECU 65 determines “Yes” and executes step processing of step S16.

In step S16, the adjustment ECU 65 determines the brake operation characteristic selected by the driver, that is, the F-S diagram L1 or the F-S diagram L2 as the brake operation characteristic when the vehicle 1 is actually braked by the pushing operation (brake operation) of the operation lever 11. When the driver pushes the operation lever 11, the adjustment ECU 65 drives the electric motor 122 so as to realize the determined brake operation characteristic.

That is, the adjustment ECU 65 drives the electric motor 122 to assist the operation force F and the stroke amount S input to the operation lever 11 by the driver so that the determined brake operation characteristic is obtained based on the stroke amount S (and/or the operation force F) detected by the stroke sensor 121 as the detection result. As a result, when braking the vehicle 1 in a situation where the vehicle 1 is traveling, the driver can push the operation lever 11 in accordance with the brake operation characteristic according to the driver's preference, for example, the brake operation characteristic in which the stroke amount S is increased or the operation force F is increased. Therefore, when the driver manually performs the brake operation, the driver can smoothly stop the vehicle 1 at an appropriate deceleration, for example, as in a case where the driver depresses the brake pedal with his/her foot.

On the other hand, in step S15, when any one brake operation characteristic is not selected from the catalog provided in step S14, the adjustment ECU 65 determines “No” and executes step processing in step S17. In step S17, the adjustment ECU 65 prompts creation of brake operation characteristics other than the brake operation characteristics provided in the catalog.

That is, for example, the adjustment ECU 65 displays, in the display device, a text message such as “Please move the points P1, P2, and P3 as appropriate to create a desired brake operation characteristic.” In this case, the adjustment ECU 65 provides, for example, an F-S diagram as shown in FIG. 6 to the driver as a reference operation characteristic. Then, the driver appropriately changes the provided F-S diagram (reference operation characteristic) to create a brake operation characteristic preferred by the driver.

As a result, for example, in the reference operation characteristic, the driver can move the point P1 so that the stroke amount S decreases in order to decrease the rising region gradient G1, or can move the point P1 so that the operation force F decreases in order to decrease the rising operation force F. Further, for example, in the reference operation characteristic, the driver can move the point P1 so that the operation force F decreases in order to decrease the normal region gradient G2, or can move the point P2 so that the stroke amount S and the operation force F increase in order to increase the stroke amount S while maintaining the normal region gradient G2. Further, for example, in the reference operation characteristic, the driver can move the point P3 so that the stroke amount S increases in order to increase the high deceleration region gradient G3, or can move the point P3 so that the stroke amount S decreases in order to decrease the high deceleration region gradient G3. When the F-S diagram, that is, the brake operation characteristic, is created (set) by the driver as described above, the adjustment ECU 65 executes step processing of step S18.

In step S18, the adjustment ECU 65 determines the brake operation characteristic created (determined) in step S17 as the brake operation characteristic selected by the driver. As a result, as in the case where the determination processing in step S16 is executed, the driver can pushes the operation lever 11 according to the created brake operation characteristic. After determining the brake operation characteristic, the adjustment ECU 65 ends the execution of the brake characteristic setup program in step S19.

As can be understood from the above description, the vehicle brake operating apparatus 10 of the present embodiment includes the steering wheel 811 serving as a steering member gripped by the hand of the driver for a steering operation, the operation lever 11 provided on the steering wheel 811 so as to be operable by the hand of the driver and serving as an operation member for at least a brake operation, the stroke sensor 121 serving as a detection device that detects an operation on the operation lever 11 by the hand of the driver, and the adjustment ECU 65 serving as a controller that obtains a detection result of the operation. Then, the adjustment ECU 65 controls, based on the detection result, the variable mechanism 12 that changes at least one of the operation force F input to the operation lever 11 by the driver in accordance with the brake operation and the stroke amount S as the operation amount.

According to the vehicle brake operating apparatus 10, the operation on the operation lever 11 provided on the steering wheel 811, that is, the operation force F and the stroke amount S, can be changed based on, for example, the operation force F and the stroke amount S (operation amount) input by the initial operation, that is, the detection result. As a result, in the vehicle brake operating apparatus 10, the brake operation characteristic suitable for the driver can be obtained, and as a result, the driver can generate a deceleration suitable for the driver's preference in the vehicle 1. Therefore, it is possible to suppress a sense of discomfort felt when the driver decelerates the vehicle by operating the operation lever 11 particularly by hand.

### FIRST MODIFICATION

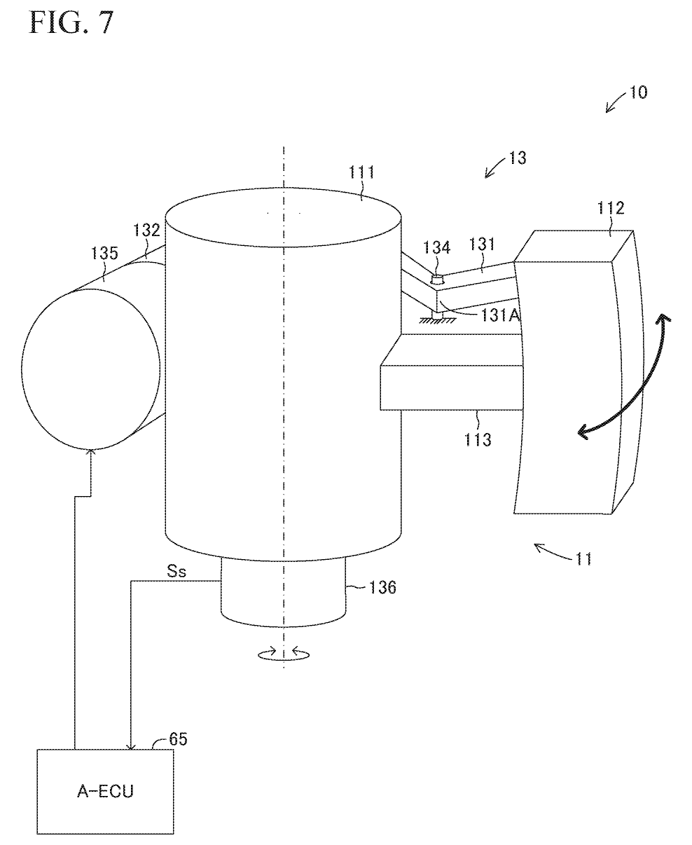

In the above-described embodiment, the case where the vehicle brake operating apparatus 10 includes the variable mechanism 12 having the electric motor 122 is exemplified. In the above-described embodiment, the adjustment ECU 65 controls the driving force generated by the electric motor 122, that is, the assist force, so that the operation lever 11 can be pushed, that is, the brake operation can be performed according to the brake operation characteristic (F-S diagram) determined by the driver. Instead, in a first modification, as shown in FIG. 7, a case where the vehicle brake operating apparatus 10 includes a variable mechanism 13 will be described.

As shown in FIGS. 7, 8, and FIG. 9, the variable mechanism 13 includes a force transmission member 131 having a bent shape, a fluid cylinder 132, a connection member 133, a pin 134, and an electric motor 135. Further, the variable mechanism 13 includes a stroke sensor 136 that is configured similarly to the stroke sensor 121 constituting the variable mechanism 12 and is coaxially assembled to the base 111.

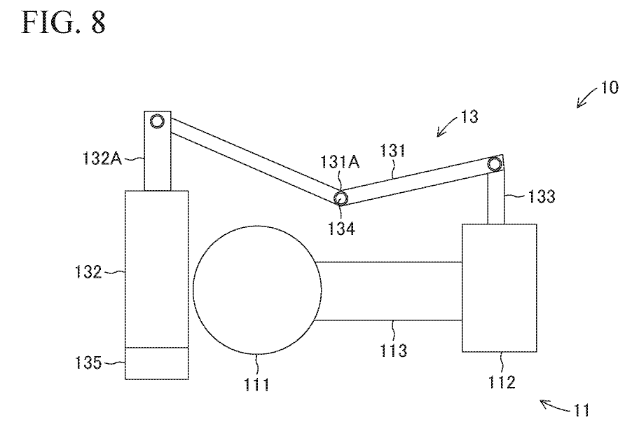

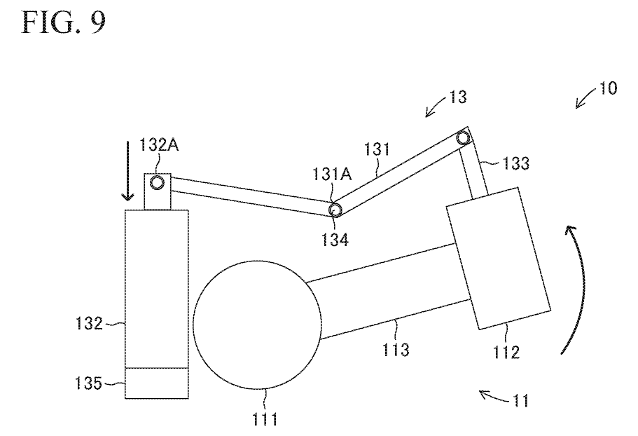

As shown in detail in FIGS. 8 and 9, one end side of the force transmission member 131 is connected to the operation portion 112 via the connection member 133. The other end of the force transmission member 131 is connected to a piston rod 132A of the fluid cylinder 132. Further, the force transmission member 131 is supported by the pin 134, which is non-rotatably fixed to a central portion 811B of the steering wheel 811, so as to be rotatable with respect to the pin 134 at a bent portion 131A, which is a bent portion provided at a substantially central portion of the force transmission member 131. In addition, the connection member 133 and the operation portion 112 are rotatably connected to each other by a so-called clevis pin provided with a clevis and inserted into the clevis. Similarly, a clevis is provided, and the force transmission member 131 and the piston rod 132A are rotatably connected by a clevis pin inserted into the clevis.

Here, since the force transmission member 131 rotatably supported by the pin 134 at the bent portion 131A and the piston rod 132A are rotatably connected by the clevis pin, when the piston rod 132A extends and contracts, the piston rod 132A extends and contracts along an axial direction of the fluid cylinder 132. Accordingly, a force in the same direction is always applied to the fluid cylinder 132, and as a result, it is possible to suppress an excessive load from being applied to the fluid cylinder 132.

The fluid cylinder 132 accommodates a gas such as air or a liquid such as hydraulic oil as a fluid, and generates a resistance force or a thrust force by movement of the fluid with displacement of the piston rod 132A along the axial direction. Accordingly, when the operation lever 11 is pushed and the operation force F is transmitted to the fluid cylinder 132 via the force transmission member 131, the fluid cylinder 132 generates the resistance force or the thrust force, so that the operation force F and the stroke amount S at the time of the pushing operation can be changed.

Here, the resistance force generated by the fluid cylinder 132 can be arbitrarily changed, for example, by changing the resistance force generated when the fluid accommodated in the fluid cylinder 132 passes through a flow path (orifice) provided inside the fluid cylinder 132 along with the extension and contraction of the piston rod 132A. It is noted that, in this case, the fluid cylinder 132 includes flow paths (orifices) having various flow path diameters through which the fluid can pass, and the flow path (orifice) having an desired flow path diameter can be switched stepwise by the electric motor 135 whose operation is controlled by the adjustment ECU 65.

Moreover, the thrust force generated by the fluid cylinder 132 can be arbitrarily changed, for example, by pressurizing or depressurizing the fluid contained in the fluid cylinder 132. It is noted that, in this case, a pump (not shown) that pressurizes or depressurizes the fluid accommodated in the fluid cylinder 132 is provided, and the adjustment ECU 65 controls the pump having an electric motor to change the pressure of the fluid, so that the thrust force for extending and contracting the piston rod 132A can be changed.

In the variable mechanism 13 of the first modification, as shown in FIG. 9, when the operation portion 112 is pushed, the force transmission member 131 rotates around the pin 134 supporting the bent portion 131A by so-called lever rotation. In this case, since the operation portion 112 rotates following the lever rotation of the force transmission member 131, a surface facing the driver (for example, a surface pushed by the thumb) is operated so as to shake the head.

Further, in this case, the force transmission member 131 acts as a lever and pushes the piston rod 132A of the fluid cylinder 132 in a contracting direction. As a result, the fluid cylinder 132 causes, for example, the resistance force to act on the piston rod 132A, so that the driver perceives, via the operation portion 112, the reaction force transmitted via the force transmission member 131. That is, the driver can perform the brake operation by inputting the operation force F to the operation lever 11 against the perceived reaction force.

Therefore, also in the variable mechanism 13 of the first modification, similarly to the above-described embodiment, when the adjustment ECU 65 determines the brake operation characteristic by executing the brake characteristic setup program, the adjustment ECU 65 controls the operation of the electric motor 135 to change a flow passage diameter of the fluid cylinder 132 so as to realize the determined brake operation characteristic. As a result, similarly to the above-described embodiment, the driver can perform the pushing operation of the operation lever 11 by the brake operation characteristics according to his/her preference, that is, the driver can perform the brake operation. Therefore, also in the first modification, the same effects as those of the above-described embodiment can be expected.

### SECOND MODIFICATION

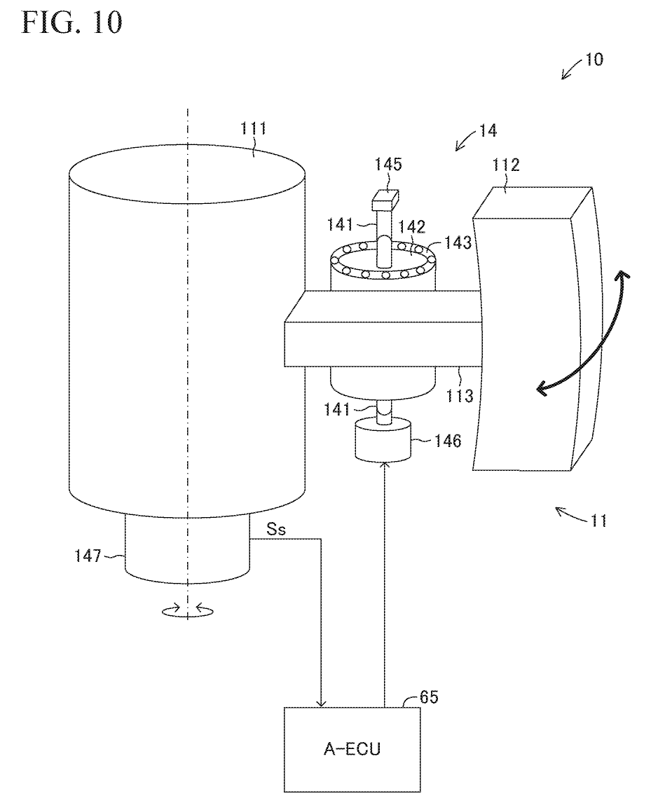

In the above-described embodiment, the case where the vehicle brake operating apparatus 10 includes the variable mechanism 12 having the electric motor 122 is exemplified. In the first modification described above, the case where the variable mechanism 13 including the force transmission member 131, the fluid cylinder 132, the connection member 133, and the pin 134 is provided is exemplified. Instead, in a second modification, as shown in FIG. 10, a case where the vehicle brake operating apparatus 10 includes a variable mechanism 14 will be described.

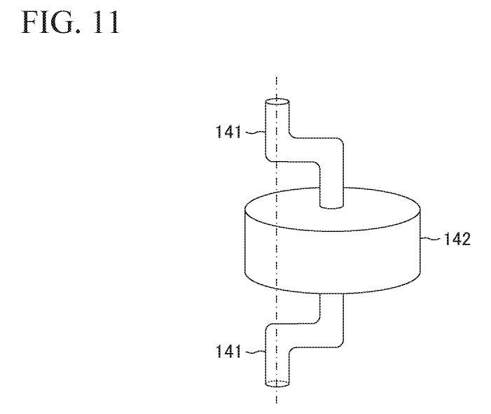

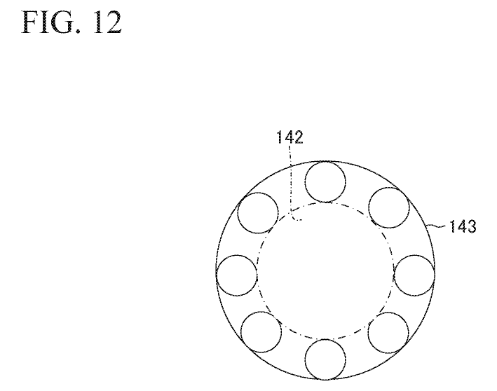

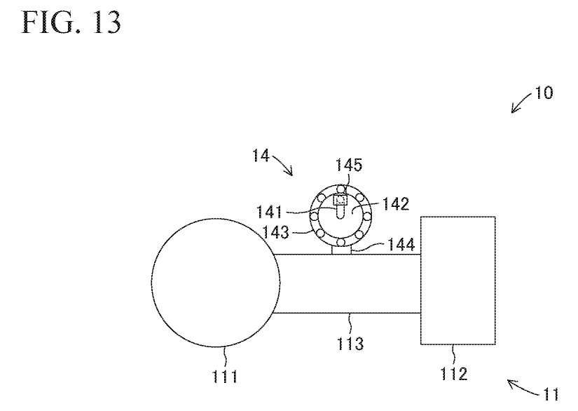

As shown in FIGS. 11 to 14, the variable mechanism 14 includes a crank member 141, an eccentric disk 142, a bearing 143, a connector 144, a bearing 145, and an electric motor 146. Further, the variable mechanism 14 includes a stroke sensor 147 which is configured similarly to the stroke sensor 121 constituting the variable mechanism 12 and is coaxially assembled to the base 111.

The crank member 141 is configured such that a rotation shaft and an off-center shaft that is off-center from the rotation shaft are connected to each other, and converts rotational motion into reciprocating motion. The eccentric disk 142 is formed in a disk shape, and is relatively rotatably coupled to the off-center shaft of the crank member 141 in a state where the off-center shaft and a central axis of the eccentric disk 142 coincide with each other. Accordingly, when the rotation shaft of the crank member 141 rotates, the eccentric disk 142 rotates around the rotation axis in an eccentric state and reciprocates. The bearing 143 includes a cylindrical outer ring that accommodates the eccentric disk 142 as an inner ring, and rolling elements (for example, balls) that support the eccentric disk 142 so as to be freely rotatable with respect to the outer ring. The connector 144 connects the outer ring of the bearing 143 and the coupling member 113 constituting the operation lever 11 to each other. The bearing 145 rotatably supports one end side (for example, an upper end side in the vertical direction) of the rotation shaft of the crank member 141. The electric motor 146 is coupled to the other end side (for example, a lower end side in the vertical direction) of the rotation shaft of the crank member 141, and eccentrically rotates and drives the eccentric disk 142 via the crank member 141. It is noted that a stepping motor or the like can be exemplified as the electric motor 146.

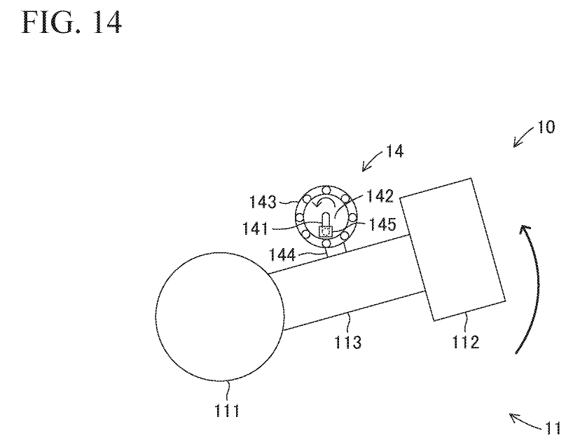

In the variable mechanism 14 of the second modification, as shown in FIG. 14, when the electric motor 146 is controlled to rotate by the adjustment ECU 65, the crank member 141 eccentrically rotates the eccentric disk 142 around the rotation axis. As a result, the bearing 143 accommodating the eccentric disk 142 as the inner ring also reciprocates in the front-rear direction of the vehicle 1 while slightly touching in the left-right direction following the eccentric rotation of the eccentric disk 142. Here, the outer ring of the bearing 143 is rotatable relative to the eccentric disk 142 and is connected to the coupling member 113 by the connector 144. Therefore, a forward movement or a backward movement (reciprocating movement) of the bearing 143 is transmitted to the operation lever 11.

Thus, in the second modification, the adjustment ECU 65 adjusts, for example, a rotation speed of the electric motor 146. That is, the adjustment ECU 65 can increase or decrease the operation force F and the stroke amount S by adjusting a timing of the forward movement or the backward movement (reciprocating movement) of the bearing 143 with respect to a pushing operation speed of the operation portion 112 by the driver, that is, a stroke speed which is a change amount per unit time of the stroke amount S detected by the stroke sensor 147.

Therefore, also in the variable mechanism 14 of the second modified example, similarly to the above-described embodiment, when the adjustment ECU 65 determines the brake operation characteristic by executing the brake characteristic setup program, for example, the adjustment ECU 65 controls the operation of the electric motor 146 to change the timing of the reciprocating motion of the eccentric disk 142, that is, the bearing 143, so as to realize the determined brake operation characteristic. As a result, similarly to the above-described embodiment, the driver can perform the pushing operation of the operation lever 11 by the brake operation characteristics according to his/her preference, that is, the driver can perform the brake operation. Therefore, also in the second modification, the same effects as those of the above-described embodiment can be expected.

What is claimed is:

1. A vehicle brake operating apparatus, comprising:
a steering member configured to be gripped by a hand of a driver for a steering operation;
an operation member configured to be provided on the steering member so as to be operable by the hand of the driver, the operation member being used for at least a brake operation;
a detection device configured to detect an operation input to the operation member by the hand of the driver; and
a controller configured to obtain a detection result of the operation,
wherein the controller is configured to control, based on the detection result, a variable mechanism that changes an operation force, an operation amount or both of the operation force and the operation amount, each of which is input to the operation member by the driver along with the brake operation.

2. The vehicle brake operating apparatus according to claim 1,
wherein the variable mechanism is configured to change the operation force, the operation amount or both of the operation force and the operation amount so as to realize one of a plurality of operation characteristics, determined by the driver, each indicating a relationship between the operation force and the operation amount in the brake operation.

3. The vehicle brake operating apparatus according to claim 2,
wherein the controller provides the plurality of operation characteristics so as to be selectable,
wherein the variable mechanism is configured to change the operation force, the operation amount or both of the operation force and the operation amount so as to realize the operation characteristic determined by the driver.

4. The vehicle brake operating apparatus according to claim 2,
wherein the variable mechanism is configured to change the operation force, the operation amount or both of the operation force and the operation amount so as to realize an operation characteristic created by the driver.

5. The vehicle brake operating apparatus according to claim 4,
wherein the controller provides a reference operation characteristic so as to allow the driver to create the operation characteristic.

6. The vehicle brake operating apparatus according to claim 1,
wherein the operation member includes:
a base rotatable around a rotation axis
an operation portion operated by the hand of the driver;
a coupling member coupling the base and the operation portion such that the operated operation portion is rotatable around the base,
wherein the variable mechanism includes an electric motor capable of changing, controlled by the controller, the operation force or both of the operation force and the operation amount each input to the operation portion.

7. The vehicle brake operating apparatus according to claim 6,
wherein the electric motor is provided to the base.

8. The vehicle brake operating apparatus according to claim 1,
wherein the operation member includes:
a base rotatable around a rotation axis
an operation portion operated by the hand of the driver;
a coupling member coupling the base and the operation portion such that the operated operation portion is rotatable around the base, and
wherein the variable mechanism includes:
a fluid cylinder capable of changing the operation force or both of the operation force and the operation amount each input to the operation portion;
a force transmission member coupling a piston rod of the fluid cylinder and a connection member connected to the operation portion so as to transmit the operation force input to the operation portion to the fluid cylinder via the piston rod, the force transmission member having a bent shape; and
a pin provided at a bent portion of the force transmission member and rotatably supporting the force transmission member around a rotation axis.

9. The vehicle brake operating apparatus according to claim 8,
wherein the fluid cylinder is configured to change a resistance force against the operation force.

10. The vehicle brake operating apparatus according to claim 9,
wherein the fluid cylinder includes an electric motor configured to change, controlled by the controller, a flow passage diameter of a flow passage through which fluid passes so as to change the resistance force.

11. The vehicle brake operating apparatus according to claim 1,
wherein the operation member includes
a base rotatable around a rotation axis
an operation portion operated by the hand of the driver;
a coupling member coupling the base and the operation portion such that the operated operation portion is rotatable around the base,
wherein the variable mechanism includes:
a crank member coupling a rotation shaft and an an off-center shaft that is off-center from the rotation shaft so as to convert rotational motion into reciprocating motion;
an eccentric disk relatively rotatably coupled to the off-center shaft in a state where the off-center shaft of the crank member and a central axis of the eccentric disk coincide with each other;
a first bearing accommodating the eccentric disk as an inner ring and including a rolling element supporting the eccentric disk so as to be freely rotatable with respect to an outer ring; and
a connector connecting the outer ring of the first bearing and the coupling member;
an electric motor coupled to the rotation shaft of the crank member and configured to eccentrically rotate, controlled by the controller, the eccentric disk so as to cause the first bearing and the connector to perform a forward movement or a backward movement.

12. The vehicle brake operating apparatus according to claim 11,
wherein the electric motor is coupled to a first end side of the crank member and a second bearing is coupled to a second end of the crank member.

13. The vehicle brake operating apparatus according to claim 2,
wherein, in the brake operation, the operation characteristic consists of (i) a rising region gradient representing the relationship between the operation force and the operation amount at an initial stage of the brake operation, (ii) a normal region gradient representing the relationship between the operation force and the operation amount when a normal deceleration is occurred, and (iii) a high deceleration region gradient representing the relationship between the operation force and the operation amount when a high deceleration is occurred.

14. The vehicle brake operating apparatus according to claim 1,
wherein the detection device is configured to detect an initial operation that is the operation input to the operation member in a state where a predetermined condition including a situation in which a stopped state is maintained is satisfied.

15. The vehicle brake operating apparatus according to claim 14,
wherein the predetermined condition includes a state where the vehicle is stopped in a situation in which at least one of the following conditions is satisfied: a shift operation member is at a parking position, a wheel speed of the wheel is 0 or a braking force is applied to the wheel by an operation of an electric parking brake device.

16. The vehicle brake operating apparatus according to claim 14,
wherein the controller is configured to prompt the driver to perform the initial operation to the operation member,
wherein the detection device is configured to detect, as the initial operation, the operation amount or both of the operation force and the operation amount each input to the operation member by the driver.
